(19) United States
(12) Patent Application Publication
(10) Pub. No.: US 2016/0249036 A1
(43) Pub. Date: Aug. 25, 2016

(54) APPARATUS AND METHOD FOR GENERATING THREE-DIMENSIONAL (3D) SHAPE OF OBJECT UNDER WATER

(71) Applicant: ELECTRONICS AND TELECOMMUNICATIONS RESEARCH INSTITUTE, Daejeon (KR)

(72) Inventors: Seong Ho SON, Daejeon (KR); Bo Ra KIM, Daejeon (KR); Soon Ik JEON, Daejeon (KR)

(21) Appl. No.: 15/049,600

(22) Filed: Feb. 22, 2016

(30) Foreign Application Priority Data
Feb. 23, 2015 (KR) 10-2015-0025117

(51) Int. Cl. H04N 13/00; H04N 13/02

(52) U.S. Cl. CPC H04N 13/0018; H04N 13/0253

(57) ABSTRACT

Provided is an apparatus and method for generating a three-dimensional (3D) shape of an object immersed in a liquid, in which the method may include receiving an image captured by photographing a section contour of the object immersed in a matching solution, generating a 3D shape of the object using the image, wherein the section contour may be formed according to a line laser emitted toward a surface of the object.

### CROSS-REFERENCE TO RELATED APPLICATION

This application claims the priority benefit of Korean Patent Application No. 10-2015-0025117, filed on Feb. 23, 2015, in the Korean Intellectual Property Office, the disclosure of which is incorporated herein by reference.

### BACKGROUND

1. Field of the Invention

Embodiments relate to an apparatus and method for generating a three-dimensional (3D) shape of an object immersed in a liquid such as a microwave matching solution.

2. Description of the Related Art

Various methods are used to generate a three-dimensional (3D) shape of an object. For example, a method of generating a 3D shape of an object by transmitting ultrasonic waves or microwaves, and calculating a distance of the object based on an amount of time in which the ultrasonic waves or the microwaves are reflected from the object may be used. Also, a method of obtaining 3D shape information using a stereo camera, or a method of emitting light, for example, pattern light, slit light, and point light, toward an object, and generating a 3D shape by applying an optical trigonometry to an image captured by photographing a result of the emitting may be used.

However, when an object is immersed in water, the methods may have issues to generate the 3D shape due to a refraction distortion due to double solution transmission, a reflection generated from an outside of a water tank, and an illusion due to a mirror effect of a surface of the water tank.

Accordingly, a method of generating a 3D shape of a breast underwater according to a predetermined distance correction method based on a refraction using a camera and a point laser is developed (application number 10-2013-0029659). However, for generating the 3D shape of the breast, the method may not be effective for implementing a device and require an amount of time for generating the 3D shape of the breast since numerous laser points are required to measure distances around the breast.

Therefore, a method of quickly generating a 3D shape of an object underwater, for example, a breast, has been requested.

### SUMMARY

An aspect provides an apparatus and method for quickly and accurately generating a three-dimensional (3D) shape of an object immersed in a matching solution.

According to an aspect, there is provided a method of generating a three-dimensional (3D) shape of an object, the method including receiving an image captured by photographing a section contour formed according to a line laser emitted toward a surface of an object immersed in a matching solution, and generating a 3D shape of the object using the image, wherein, under a water tank containing the matching solution, the line laser is emitted toward the surface of the object by a line laser emitter changing an azimuth angle at which the line laser is emitted toward the object.

The generating may include extracting the section contour as pixel coordinates of the object, converting the pixel coordinates of the section contour to absolute space coordinates; and generating the 3D shape of the object based on the absolute space coordinates.

The converting may include correcting the pixel coordinates based on underwater distortion information and converting the pixel coordinates to the absolute space coordinates.

The underwater distortion information may be generated by matching the pixel coordinates of a sample image generated by photographing a grid board to the absolute space coordinates of the grid board calculated based on a grid edge distribution of the grid board.

The generating may include generating the 3D shape of the object by applying at least one of smoothing, an interpolation, and an extrapolation to the absolute space coordinates.

According to another aspect, there is provided an apparatus for generating a three-dimensional (3D) shape of an object, the apparatus including a receiver to receive an image captured by photographing a section contour formed according to a line laser emitted toward a surface of an object immersed in a matching solution, and a processor to generate a 3D shape of the object using the image, wherein, under a water tank containing the matching solution, the line laser is emitted toward the surface of the object by a line laser emitter changing an azimuth angle at which the line laser is emitted toward the object.

The processor may extract the section contour as pixel coordinates, convert the pixel coordinates of the section contour to absolute space coordinates, and generate the 3D shape of the object based on the absolute space coordinates.

The processor may correct the pixel coordinates based on underwater distortion information according to a refraction distortion feature of the matching solution and convert the pixel coordinates to the absolute space coordinates.

The underwater distortion information may be generated by matching the pixel coordinates of a sample image generated by photographing a grid board to the absolute space coordinates of the grid board calculated based on a grid edge distribution of the grid board.

The processor may generate the 3D shape of the object by applying at least one of smoothing, an interpolation, and an extrapolation to the absolute space coordinates.

According to still another aspect, there is provided an image generating apparatus including a water tank containing a matching solution, a line laser emitter to emit a line laser toward an object immersed in the matching solution and form a section contour, a camera to photograph the section contour formed on a surface of the object and generate an image for generating a 3D shape of the object, and a rotating plate including the line laser emitter and the camera and disposed under the water tank to rotate in a horizontal direction, thereby changing an azimuth angle at which the line laser is emitted from the line laser emitter toward the object.

The camera may be disposed vertically with respect to a line toward which the line laser is emitted from the line laser emitter.

The image generating apparatus may further include an additional line laser emitter disposed on a line identical to a line toward which the line laser is emitted from the line laser emitter.

The camera may transmit the image to a 3D shape generating apparatus, and the 3D shape generating apparatus may generate the 3D shape of the object using the image.

The 3D shape generating apparatus may extract a section contour as pixel coordinates of the object, convert the pixel coordinates of the section contour to absolute space coordinates, and generate the 3D shape of the object based on the absolute space coordinates.

The camera may generate a sample image by photographing a grid board immersed in the matching solution, and the 3D shape generating apparatus may generate underwater distortion information by matching the pixel coordinates of the sample image to the absolute space coordinates of the grid board calculated based on a grid edge distribution of the grid board.

The 3D shape generating apparatus may generate, based on the underwater distortion information, the 3D shape of the object by converting the pixel coordinates extracted from the section contour of the image to the absolute space coordinates.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a three-dimensional (3D) shape generating system according to an embodiment;

FIG. 2 is a diagram illustrating an example of an image generating apparatus according to an embodiment;

FIG. 3 is a diagram illustrating an image generating apparatus according to an embodiment;

FIG. 4 is a diagram illustrating a 3D shape generating apparatus according to an embodiment;

FIG. 5 is a diagram illustrating an example of generating underwater distortion information according to an embodiment;

FIG. 6 is a diagram illustrating an example of a 3D shape generated according to an embodiment;

FIG. 7 is a flowchart illustrating a method of operating an image generating apparatus according to an embodiment;

FIG. 8 is a flowchart illustrating a method of generating a 3D shape of an object according to an embodiment; and

FIG. 9 is a flowchart illustrating a 3D shape generating process of a method of generating a 3D shape of an object according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures. A method of generating a three-dimensional (3D) shape of an object according to an embodiment may be performed by a 3D shape generating apparatus of a 3D shape generating system.

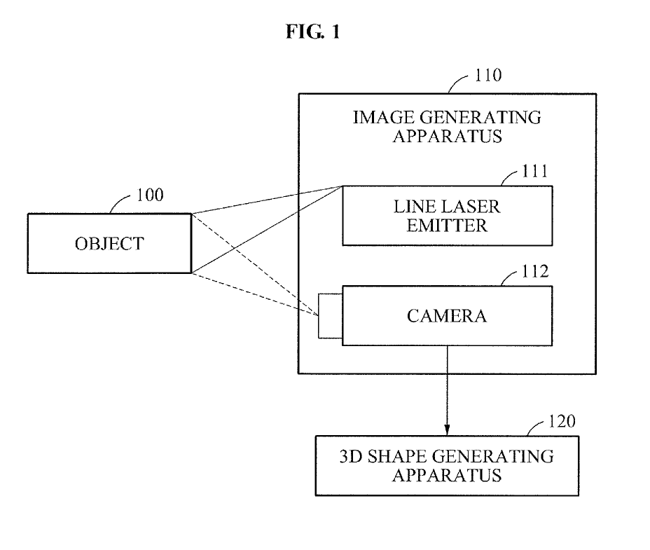

FIG. 1 is a diagram illustrating a 3D shape generating system according to an embodiment.

Referring to FIG. 1, the 3D shape generating system includes an image generating apparatus 110 and a 3D shape generating apparatus 120. For example, a 3D shape generating system may be a microwave breast tomography system to measure a 3D shape of a breast immersed in a water tank containing a matching solution.

The image generating apparatus 110 may generate an image captured by photographing a section contour of an object 100 immersed in the matching solution. Here, the image generating apparatus 110 may emit a line laser toward a surface of the object 100 by a line laser emitter 111 and form a section contour indicating a boundary between the object 100 and the matching solution in which the object 100 is immersed.

The image generating apparatus 110 may generate a digital image by photographing the object 100 of which the section contour is formed by a camera 112. Here, the image generating apparatus 110 may transmit the generated digital image to the 3D shape generating apparatus 120.

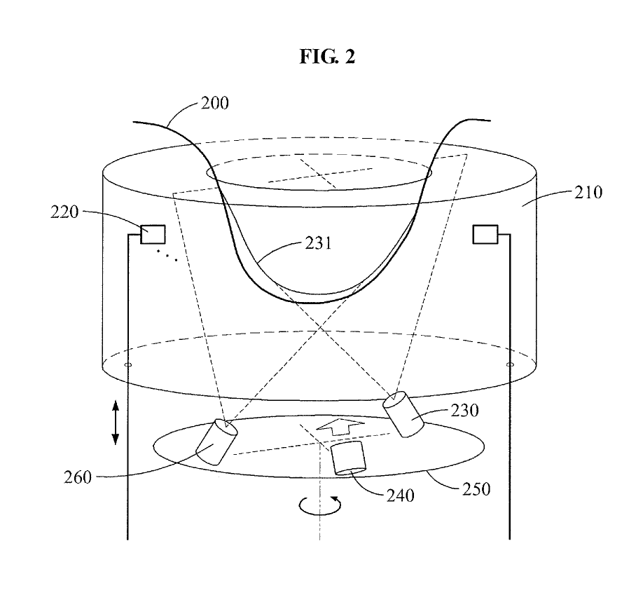

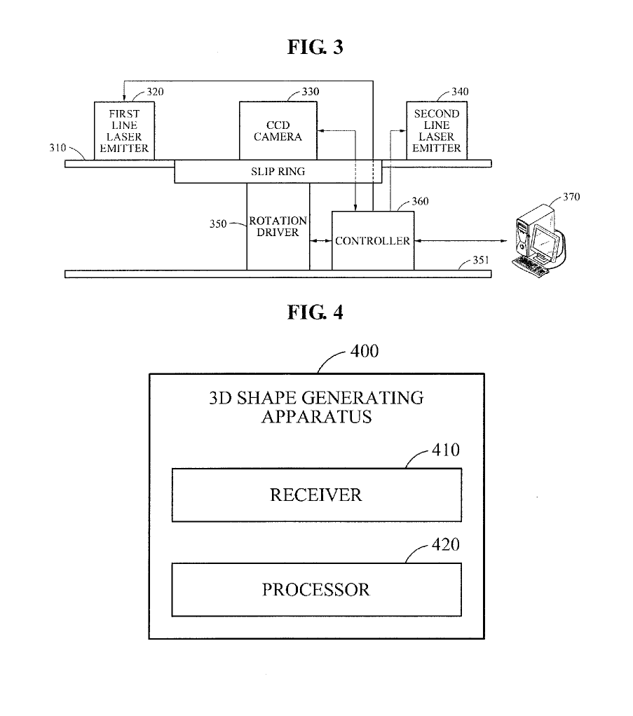

Hereinafter, the detailed configuration and operation of the image generating apparatus 110 will be provided with reference to FIGS. 2 and 3.

The 3D shape generating apparatus 120 may generate a 3D shape of the object 100 based on the digital image received from the image generating apparatus 110. The 3D shape generating apparatus 120 may extract the section contour included in the digital image as pixel coordinates of the object 100. Also, the 3D shape generating apparatus 120 may generate the 3D shape of the object 100 by converting the extracted pixel coordinates to absolute space coordinates based on underwater distortion information.

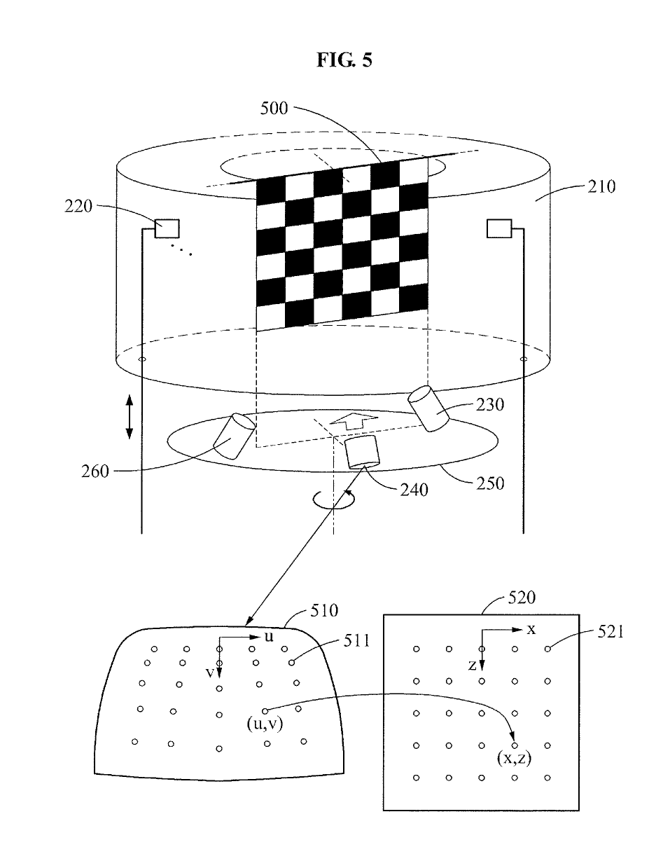

Hereinafter, the detailed configuration and operation of the 3D shape generating apparatus 120 will be provided with reference to FIG. 4.

The 3D shape generating system according to an embodiment may quickly and accurately generate a 3D shape of an object immersed in a matching solution by generating the 3D shape of the object in consideration of an underwater distortion based on a section contour formed by emitting a line laser toward the object.

FIG. 2 is a diagram illustrating an example of an image generating apparatus according to an embodiment.

Referring to FIG. 2, an object is immersed in a matching solution contained in a water tank 210. Here, at least one wave transmitting and receiving antenna 220 used for tomography of an object is included in the water tank 210. The wave transmitting and receiving antenna 220 may be vertically moved for the tomography of the object.

Accordingly, the image generating apparatus 110 may be disposed under the water tank 210 so that the image generating apparatus 110 is not influenced by the vertical movement of the wave transmitting and receiving antenna 220.

The image generating apparatus 110 may dispose a first line laser emitter 230 and a camera 230 above a rotating plate 250. Here, the first line laser emitter 230 emits a line laser toward an object 200 and forms a section contour 231 indicating a boundary between the object 200 and a matching solution.

As illustrated in FIG. 2, when a plurality of line laser emitters is provided, a second line laser emitter 260 may be disposed at a position of the rotating plate 250 at which a line emitting a line laser is co-linear with the first line laser 230.

As illustrated in FIG. 2, to photograph the section contour 231, the camera 240 is disposed vertically with respect to a line toward which line lasers emitted from the first line laser emitter 230 and the second line laser emitter 260.

Also, according to the object 200, the image generating apparatus 110 disposes the first line laser emitter 230 at a center of the rotating plate 230 and forms the section contour 231 which is vertical with respect to a surface of the object 200.

Here, the rotating plate 250 rotates in a horizontal direction thereby changing an azimuth angle at which the line laser is emitted toward the object 200.

FIG. 3 is a diagram illustrating an image generating apparatus according to an embodiment.

As illustrated in FIG. 3, the image generating apparatus 110 includes a rotating plate 310, a first line laser emitter 320, a charge-coupled device (CCD) camera 330, a second line laser emitter 340, a rotation driver 350, and a controller 360.

The rotating plate 310 is disposed under a water tank to rotate. The rotating plate 310 further includes a slip ring to prevent a line connected between the first line laser emitter 320, the CCD camera 330, the second line laser emitter 340, and the controller 360 from becoming entangled. When the line connected between the first line laser emitter 320, the CCD camera 330, the second line laser emitter 340, and the controller 360 becomes entangled, an operation error may occur since a power or a control signal provided for the first line laser emitter 320, the CCD camera 330, and the second line laser emitter 340 by the controller 360 is not transmitted.

The first line laser emitter 320 and the second line laser emitter 340 are disposed above the rotating plate 310 as illustrated in FIG. 3. According to the rotation of the rotating plate 310, the first line laser emitter 320 and the second line laser emitter 340 may rotate in a horizontal direction and form a section contour by emitting a line laser toward an object.

The camera 330 is disposed above the rotating plate 310 as illustrated in FIG. 3. Here, the camera 330 may be disposed vertically with respect to a line toward which the line laser is emitted from the first line laser emitter 320 and the second line laser emitter 340. The camera 330 may generate a digital image by photographing the section contour formed by rotating in a horizontal direction according to the rotation of the rotating plate 310.

The rotation driver 350 may include a motor to rotate the rotating plate 310 in a horizontal direction. The rotation driver 350 may be disposed at a lower side 351 of the water tank containing a matching solution.

The controller 360 may control a power of the first line laser emitter 320, the CCD camera 330, the second line laser emitter 340, and the rotation driver 350. The controller 360 may control whether the first line laser emitter 320 and the second line laser emitter 340 emit a line laser. Also, the controller 360 may control an angle of a line laser emission.

The controller 360 may transmit the digital image generated by the CCD camera 330 to a terminal 370, for example, a personal computer (PC), including the 3D shape generating apparatus 120. The controller 360 may include the 3D shape generating apparatus 120 and output a 3D shape generated by processing the digital image generated by the CCD camera 330.

FIG. 4 is a diagram illustrating a 3D shape generating apparatus according to an embodiment.

As illustrated in FIG. 4, a 3D shape generating apparatus 400 includes a receiver 410 and a processor 420. For example, the 3D shape generating apparatus 120 may be provided in a terminal in a form of a program or an application. Also, the 3D shape generating apparatus 120 may be included in the controller 360.

The receiver 410 receives a digital image captured by photographing a section contour of an object from the image generating apparatus 110.

The processor 420 generates a 3D shape of an object using the digital image received by the receiver 410.

The processor 420 extracts the section contour formed by a line laser in the digital image as pixel coordinates of the object.

The processor 420 converts the extracted pixel coordinates of the object as absolute space coordinates. Here, the processor 420 may correct the pixel coordinates of the object based on underwater distortion information and converts the pixel coordinates as the absolute space coordinates.

The underwater distortion information may be information on distortion generated in a process in which light penetrates a matching solution containing the object. For example, when an object immersed in a matching solution, for example, water, is observed from an outside, a shape of which an entirety or a portion of the object is refracted may be observed according to a light refraction feature of water. Accordingly, the processor 420 may correct the shape of the object refracted by the matching solution in the digital image by correcting the pixel coordinates of the object based on the underwater distortion information of the matching solution.

Here, the processor 420 calculates the absolute space coordinates of a grid board based on a grid edge distribution of the grid board in which a distance between blocks is determined in advance. The processor 420 generates the underwater distortion information by matching the absolute space coordinates of the gird board to pixel coordinates of a sample image generated by photographing the grid board. For example, underwater distortion information may be a function of mapping pixel coordinates of a sample image to absolute space coordinates.

The processor 420 generates a 3D shape of an object based on the absolute space coordinates of the object. Here, the processor 420 may generate the 3D shape of the object by applying at least one of smoothing, an interpolation, and an extrapolation to the absolute space coordinates. The processor 420 may store or output information of the generated 3D shape of the object.

FIG. 5 is a diagram illustrating an example of generating underwater distortion information according to an embodiment.

The 3D shape generating apparatus 120 determines underwater distortion information by the matching solution contained in the water tank 210 using a grid board 500 inserted to the water tank 210 in which the image generating apparatus 110 is included. Here, a distance between blocks formed in the grid board 500 is regular and the 3D shape generating apparatus 120 may receive an input of the distance between the blocks formed in the grid board 500.

As illustrated in FIG. 5, the grid board 500 may be inserted to the water tank 210 according to a vertical plane in which a line laser is emitted by the first line laser emitter 230 and the second line laser emitter 260. The camera 240 may be disposed in front of the grid board 500 and photograph the grid board 500.

As illustrated in FIG. 5, a distance between grid edges 511 in the sample image 510 generated by photographing the grid board 500 by the camera 240 may not be regular due to a penetration distortion feature of the matching solution.

Here, the 3D shape generating apparatus 120 may determine a reference coordinate 520 by identifying coordinates x and y of the grid edges 521 formed in the grid board 500 based on the received distance between the blocks. As shown in Equation 1, the 3D shape generating apparatus 120 may calculate a function F(u,v) and G(u,v) indicating a conversion relationship between coordinates u and v, and coordinates x and y, using the coordinates x and y of the grid edges 521 and the coordinates u and v of the grid edges 511 of the sample image 510.

x=F(u,v), y=G(u,v) [Equation 1]

In Equation 1, the function F(u,v) and G(u,v) may be a polynomial function.

The 3D shape generating apparatus 120 may use the function F(u,v) and G(u,v) as the underwater distortion information and apply the function F(u,v) and G(u,v) to values u and v of the pixel coordinates extracted from the section contour. The 3D shape generating apparatus 120 may determine values x, y, and z of 3D space coordinates by calculating heights of the values x and z of the absolute space coordinates based on photographing angle information of the camera 240.

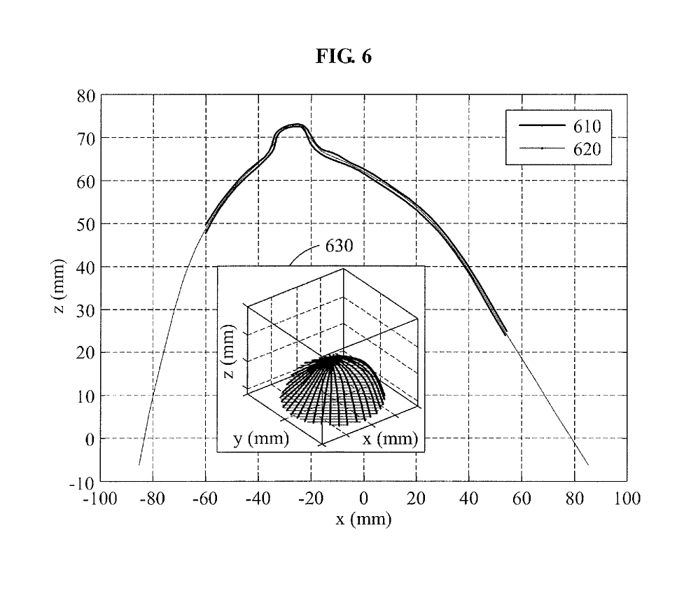

FIG. 6 is a diagram illustrating an example of a 3D shape generated according to an embodiment.

Referring to FIG. 6, before-processing information 610 is a result in which the 3D shape generating apparatus 120 applies the underwater distortion information to the pixel coordinates extracted from the section contour and converts the pixel coordinates to the absolute space coordinates.

The after-processing information 620 is a result in which the 3D shape generating apparatus 120 performs smoothing and interpolation on the absolute space coordinates, and extrapolation on a shading area which is not measured.

The 3D shape generating apparatus 120 may generate the 3D shape, for example, a final recon shape, using the after-processing information 620 generated based on images captured by the image generating apparatus 110 of which the line laser emitter 111 and the camera 112 rotate and photograph.

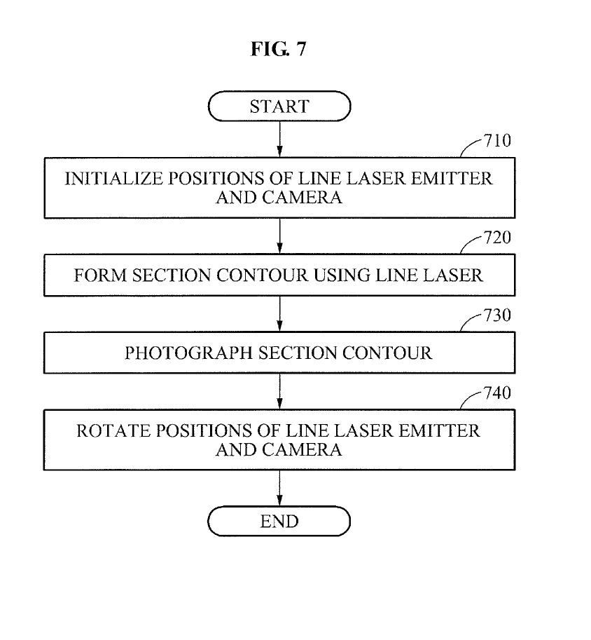

FIG. 7 is a flowchart illustrating a method of operating an image generating apparatus according to an embodiment.

In operation 710, the image generating apparatus 110 initializes positions of the line laser emitter 111 and the camera 112 by rotating a rotating plate on which the line laser emitter 111 and the camera 112 are disposed to be at a preset initial position.

In operation 720, the image generating apparatus 110 provides power for the line laser emitter 111 and enables the line laser emitter 111 to emit a line laser toward the object 100. Here, the line laser emitted toward the object 100 may form a section contour vertically with respect to a surface of the object.

In operation 730, the image generating apparatus 110 generates a digital image and photographs the section contour formed by the camera 112 in operation 720. The image generating apparatus 110 may transmit the digital image to the 3D shape generating apparatus 120.

In operation 740, the image generating apparatus 110 rotates the rotating plate to rotate positions of the line laser emitter 111 and the camera 112. The image generating apparatus 110 may generate the digital image with respect to all azimuth angles of the object 100 by iteratively performing operations 720 through 740.

FIG. 8 is a flowchart illustrating a method of generating a 3D shape of an object according to an embodiment.

In operation 810, the 3D shape generating apparatus 120 receives a digital image captured by photographing a section contour from the image generating apparatus 110. Here, the digital image received by the 3D shape generating apparatus 120 may be a digital image generated by the image generating apparatus 110 according to the method described in FIG. 7.

In operation 820, the 3D shape generating apparatus 120 generates a 3D shape of the object 100 using the digital image received in operation 810. The 3D shape generating apparatus 120 may extract the section contour included in the digital image as pixel coordinates of the object 100. The 3D shape generating apparatus 120 may generate the 3D shape of the object 100 by converting the extracted pixel coordinates of the object 100 to absolute space coordinates based on underwater distortion information.

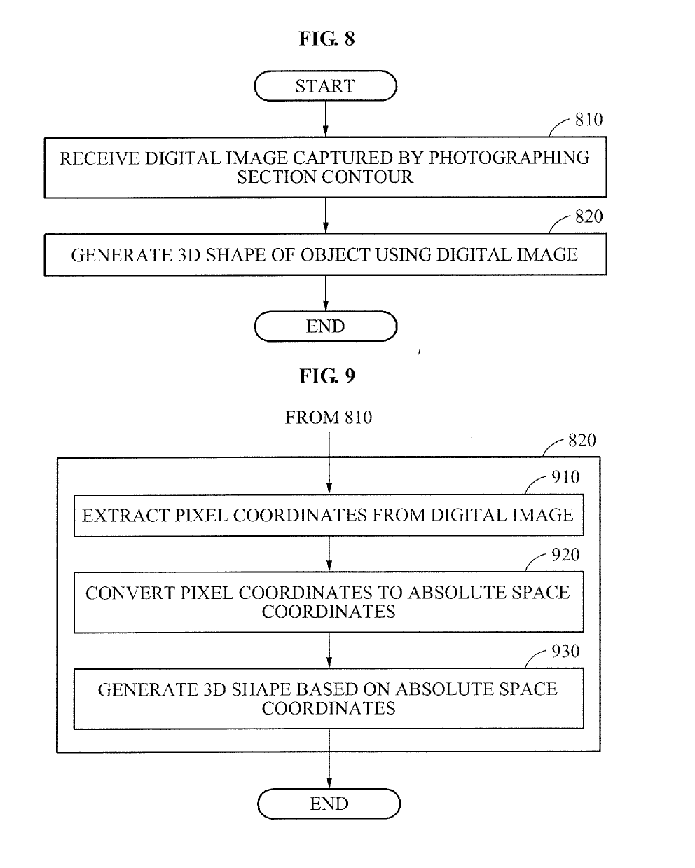

FIG. 9 is a flowchart illustrating a 3D shape generating process of a method of generating a 3D shape of an object according to an embodiment. Operations 910 through 930 in FIG. 9 may be included in operation 820 in FIG. 8.

In operation 910, the 3D shape generating apparatus 120 extracts, as pixel coordinates of an object, the section contour formed by the line laser from the digital image received in operation 810.

In operation 920, the 3D shape generating apparatus 120 converts the extracted pixel coordinates in operation 910 to absolute space coordinates. The 3D shape generating apparatus 120 may correct the pixel coordinates based on underwater distortion information determined based on an identical method of FIG. 5 and convert the pixel coordinates to the absolute space coordinates of the object.

In operation 930, the 3D shape generating apparatus 120 generates the 3D shape of the object based on the converted absolute space coordinates of the object in operation 920. The 3D shape generating apparatus 120 generates the 3D shape by applying at least one of smoothing, an interpolation, and an extrapolation to the absolute space coordinates of the object.

According to the present exemplary embodiment, it is possible to quickly and accurately generate a 3D shape of an object immersed in a matching solution by generating the 3D shape of the object in consideration of underwater distortion based on a section contour formed by emitting a line laser toward the object.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of generating a three-dimensional (3D) shape of an object, the method comprising:
receiving an image captured by photographing a section contour formed according to a line laser (*laser beam? emitted toward a surface of an object immersed in a matching solution; and
generating a 3D shape of the object using the image;
wherein, under a water tank containing the matching solution, the line laser is emitted toward the surface of the object by a line laser emitter changing an azimuth angle at which the line laser is emitted toward the object.

2. The method of claim 1, wherein the generating comprises:
extracting the section contour as pixel coordinates of the object;
converting the pixel coordinates of the section contour to absolute space coordinates; and
generating the 3D shape of the object based on the absolute space coordinates.

3. The method of claim 2, wherein the converting comprises correcting the pixel coordinates based on underwater distortion information and converting the pixel coordinates to the absolute space coordinates.

4. The method of claim 3, wherein the underwater distortion information is generated by matching the pixel coordinates of a sample image generated by photographing a grid board to the absolute space coordinates of the grid board calculated based on a grid edge distribution of the grid board.

5. The method of claim 2, wherein the generating comprises generating the 3D shape of the object by applying at least one of smoothing, an interpolation, and an extrapolation to the absolute space coordinates.

6. An apparatus for generating a three-dimensional (3D) shape of an object, the apparatus comprising:
a receiver to receive an image captured by photographing a section contour formed according to a line laser emitted toward a surface of an object immersed in a matching solution; and
a processor to generate a 3D shape of the object using the image;
wherein, under a water tank containing the matching solution, the line laser is emitted toward the surface of the object by a line laser emitter changing an azimuth angle at which the line laser is emitted toward the object.

7. The apparatus of claim 6, wherein the processor extracts the section contour as pixel coordinates, converts the pixel coordinates of the section contour to absolute space coordinates, and generates the 3D shape of the object based on the absolute space coordinates.

8. The apparatus of claim 7, wherein the processor corrects the pixel coordinates based on underwater distortion information according to a refraction distortion feature of the matching solution and converts the pixel coordinates to the absolute space coordinates.

9. The apparatus of claim 8, wherein the underwater distortion information is generated by matching the pixel coordinates of a sample image generated by photographing a grid board to the absolute space coordinates of the grid board calculated based on a grid edge distribution of the grid board.

10. The apparatus of claim 7, wherein the processor generates the 3D shape of the object by applying at least one of smoothing, an interpolation, and an extrapolation to the absolute space coordinates.

11. An image generating apparatus, comprising:
a water tank to contain a matching solution;
a line laser emitter to emit a line laser toward an object immersed in the matching solution and form a section contour;
a camera to photograph the section contour formed on a surface of the object and generate an image for generating a 3D shape of the object; and
a rotating plate including the line laser emitter and the camera and disposed under the water tank to rotate in a horizontal direction, thereby changing an azimuth angle at which the line laser is emitted from the line laser emitter toward the object.

12. The method of claim 11, wherein the camera is disposed vertically with respect to a line toward which the line laser is emitted from the line laser emitter.

13. The apparatus of claim 11, further comprising:
an additional line laser emitter disposed on a line identical to a line toward which the line laser is emitted from the line laser emitter.

14. The apparatus of claim 11, wherein the camera transmits the image to a 3D shape generating apparatus, and the 3D shape generating apparatus generates the 3D shape of the object using the image.

15. The apparatus of claim 14, wherein the 3D shape generating apparatus extracts a section contour as pixel coordinates of the object, converts the pixel coordinates of the section contour to absolute space coordinates, and generates the 3D shape of the object based on the absolute space coordinates.

16. The apparatus of claim 14, wherein the camera generates a sample image by photographing a grid board immersed in the matching solution, and the 3D shape generating apparatus generates underwater distortion information by matching the pixel coordinates of the sample image to the absolute space coordinates of the grid board calculated based on a grid edge distribution of the grid board.

17. The apparatus of claim 16, wherein the 3D shape generating apparatus generates, based on the underwater distortion information, the 3D shape of the object by converting the pixel coordinates extracted from the section contour of the image to the absolute space coordinates.
